(19) United States
(12) Patent Application Publication
(10) Pub. No.: US 2016/0108660 A1
(43) Pub. Date: Apr. 21, 2016

(54) Door Leaf Device for Mass Transportation Vehicles and Method for the Production of Such a Door

(71) Applicant: VAPOR EUROPE S.R.L., Sassuolo (MO) (IT)

(72) Inventors: Gerald Matzka, Brunn am Gebirge (AT); Alois Ritt, Amstetten (AT)

(21) Appl. No.: 14/892,108

(22) PCT Filed: May 22, 2014
(86) PCT No.: PCT/EP2014/060571

§ 371 Date: Nov. 18, 2015

(30) Foreign Application Priority Data
May 24, 2013 (EP) 13169231.1

(51) Int. Cl. E06B 3/70; B61D 19/02

(52) U.S. Cl. CPC E06B 3/7015; B61D 19/02; E06B 2003/7023

(57) ABSTRACT

A door leaf device for mass transportation vehicles is provided. The door leaf device comprises first and second panels, having opposing inner side surfaces, forming an inner space in between and a core layer, filling the inner space between the inner side surfaces of the first and second panels. The inner side surfaces of the first and second panels each comprise at least one fastening means or element, engaging the core layer.

The invention relates to a door leaf device for mass transportation vehicles according to claim 1, to a method for producing a door leaf device for mass transportation vehicles according to claim 11, to a door for mass transportation vehicles according to claim 12 and to a mass transportation vehicle according to claim 13.

Mass transportation vehicles, such as the mass transportation vehicle known e.g. from U.S. Pat. No. 4,233,904 or DE 196 19 212 A1 comprise doors to enter and exit the vehicle.

Mass transportation vehicle doors and in particular door leaf devices of such doors on the one hand have to by robust since they are subject to high stress. On the other hand such doors and door leafs have to be as light as possible. Usually, the doors of mass transportation vehicles are designed as sliding doors.

Mass transportation vehicle doors are known, wherein a frame, in particular an aluminum frame or alternatively a stainless steel or steel frame, defining the shape of the door, is attached with an inner and an outer panel. A hollow space between the panels and inside the frame may be for example filled with fiber mats for temperature and/or noise isolation. The inner and outer panels often are fastened to the frame by means of gluing, rivets or by welding.

The object of the invention is therefore to provide an improved door leaf device, in particular a door leaf device for mass transportation vehicles, which is robust, light and inexpensive in production.

Said object is achieved by means of a door leaf device, having the features of claim 1.

Such a door leaf device for mass transportation vehicles comprises first and second panels, having opposing inner side surfaces, forming an inner space in between, and a core layer, filling the inner space between the inner side surfaces of the first and second panels. The door leaf device is characterized in that the inner side surfaces of the first and second panels each comprise at least one fastening means, engaging the core layer.

The door leaf device may particularly be used in mass transportation vehicles, such as trains, subways, trams, busses, airplanes, cable cars, street cars, etc.; however, the door leaf device may also be used elsewhere, e.g. for room doors, front doors, balcony doors, and others.

Such a door leaf device is light, since the size of the frame structure may be reduced or the frame may even be abandoned. Such panels are inexpensive in production, since instead of screws, rivets and/or a welding procedure, the panels may be fixed with respect to one another via and by means of the core layer.

As fastening means especially any conceivable means may be applied, which serves for fastening the first and/or second panels to the core layer by engaging the core layer. In cross section, particularly suitable forms are e.g. T-shapes, L-shapes or quarter circles, but any other forms which may serve for fastening the first and/or second panels to the core layer by engaging the core layer are also conceivable.

It is further conceivable, that the fastening means of the first panel and the fastening means of the second panel overlap each other. Therefore, the fastening means may for example be formed in an L-shape with opposite orientation on the first and on the second panels. In this manner, the fastening means of the panels may engage (with or without direct contact) with each other and secure the first and second panels with respect to one another. Such an arrangement may serve as a (metallic) protection in case of a failure of the core layer (e.g. due to wear, heavy load and/or in case of an accident).

The fastening means may be distributed over the panels in regular or in irregular distances to each other. E.g. there could be provided more fastening means in those areas of the door leaf device, that are subject to high stress and few fastening means in areas of the door leaf device, that are subject to low stress only. The fastening means may be formed or placed on distinct spots of the first and second panels, they may also be formed elongate and extend over the panels.

The first and second panels may be fastened to the core layer by means of the fastening means. The engagement of the fastening means and the core layer may be a form-locking engagement, fastening the first and/or second panels to the core layer.

The door leaf device may be configured such, that the core layer comprises a foam material such as polyurethane (PU) foam, XPS foam, PVC foam and/or PET foam or any other suitable material. The core layer may in particular comprise rigid PU foam with a density of 30 to 300 kg/m³, and very particular rigid PU foam with a density of 50 to 100 kg/m³. In the construction of the door leaf device foam materials may be used e.g. in liquid form or in the shape of panels.

The core layer may also comprise another rigid foam material as other synthetic foam or metal foam or may comprise a combination of different foam materials or a combination of one or more foam materials with one or more other materials. A core layer may be at least partially made of foam material; however, the core layer does not necessarily have to be made of a foam material. Foam material or another suitable material having the required physical properties, in particular with respect to rigidity, acoustics and durability, in particular PU foam, may be used for producing the core layer since such foam is particularly light, inexpensive and robust.

Furthermore, the core layer may comprise more than one material. For example, two or more materials with the same or a different hardness may be applied in the door leaf device depending on the respective local load or strain.

Furthermore, a foam material may be introduced, injected, pressed or poured into the inner space between the first and second panels. After curing the foam, it may become rigid and may be engaged by fastening means, such that the first and second panels are fastened with respect to one another by means of and via the core layer. Furthermore, the foam material may also be cured first, provided with recesses corresponding to the fastening means of the first and second panels, and then be introduced in the inner space between the panels with the fastening means engaging the recesses. The core layer material may also be cut into panels and provided with undercuts (e.g. by mechanical processing) which interlink with the fastening means of the first and second panels. Moreover and alternatively, foam may first be applied to the first panel, the second panel being placed on the foam thereafter.

It is also conceivable, that the fastening means are pressed into a pre-formed core layer panel, cutting into the core layer material, and brought in a form-locking engagement with the core layer in this way. Therefore, the fastening means may particularly be formed (at least in cross-section) in shape of arrows.

A foam-filling of foam in the inner space between the first and second panels may be carried out such that a laminar foam-filling of the panels is achieved.

The foam material, when being introduced into the inner space between the first and second panels, may encompass the fastening means, provided in or on the first and second panels. Thus, an engagement of the fastening means with the core layer may be provided, fastening the first and/or second panels to the core layer.

The door leaf device may further be configured such, that the first and/or second panels comprise metal, in particular aluminum, and/or plastics. The first and second panels can also comprise other materials, e.g. any other metal, synthetic material or wood. The panels may comprise a combination of different materials or be made of one specific material.

The first and/or second panels of the door leaf device may be manufactured by rolling, extruding or casting, in particular, when the first and/or second panels are made of aluminum, plastics or stainless steel.

According to an aspect of the invention, the door leaf device may be configured such, that the at least one fastening means of the first and second panels are formed integrally in one piece with the first and/or second panels. This configuration may be applied in particular when the first and/or second panels are manufactured by extruding or casting. In this case, the production of the door leaf device may be particularly easy and inexpensive since the fastening means do not have to be arranged or fixed on the panels in additional procedural steps.

According to another aspect of the invention, the door leaf device may be configured such, that the at least one fastening means of the first and second panels are separate pieces and arranged on the first and/or second panels. Producing fastening means integrally formed in one piece with the first and/or second panels may limit the possible shapes of the fastening means, especially, when the panels are produced by casting or extruding. When the fastening means are produced as separate pieces and arranged or fastened on the panels, more freedom in designing the shape or arrangement of the fastening means may be achieved. An attachment of the fastening means to the panels may be conducted e.g. by means of welding, gluing, using screws, rivets, or by any other means suitable for securely attaching the fastening means to the panels.

Furthermore, the door leaf device may be configured such, that the at least one fastening means of the first and second panels are formed as undercut or indentation in the first and/or second panels. The undercut/indentation may be formed by a recess in the panel or may be formed by a projection or protrusion on the panel.

It may be appreciated, that a door leaf device according to any of the aspects or embodiments described herein may have one or more of the following features, especially in comparison with door leafs according to the state of the art: it may be particularly light, rigid, robust, heat insulating, noise protecting and inexpensive in its production.

Said object is furthermore achieved by a method for the production of a door leaf device, according to the features of claim 11.

This method for producing a door leaf device for mass transportation vehicles, comprises the steps of: Producing first and second panels having inner side surfaces; arranging the first and second panels, facing each other with the inner side surfaces, to form an inner space in between; and filling the inner space between the first and second panels with a core material. Therein, it is foreseen, that the inner side surfaces of the first and second panels each comprise at least one fastening means, engaging the core layer.

The method for the production of a door leaf device may be adapted to produce the door leaf device according to any aspect or embodiment described herein, as well as any combination of aspects and/or embodiments described herein.

According to another aspect of the invention, a door for mass transportation vehicles is provided, comprising a door leaf device according to any aspect or embodiment described herein, being produced using said method for the production of a door leaf device, likewise according to any aspect or embodiment described herein.

According to another aspect of the invention, a mass transportation vehicle or wagon is provided, comprising at least one door leaf device according to any aspect or embodiment described herein.

Additional features and aspects of the invention will be explained in more detail in the following description of exemplary embodiments with reference to the accompanying figures, wherein:

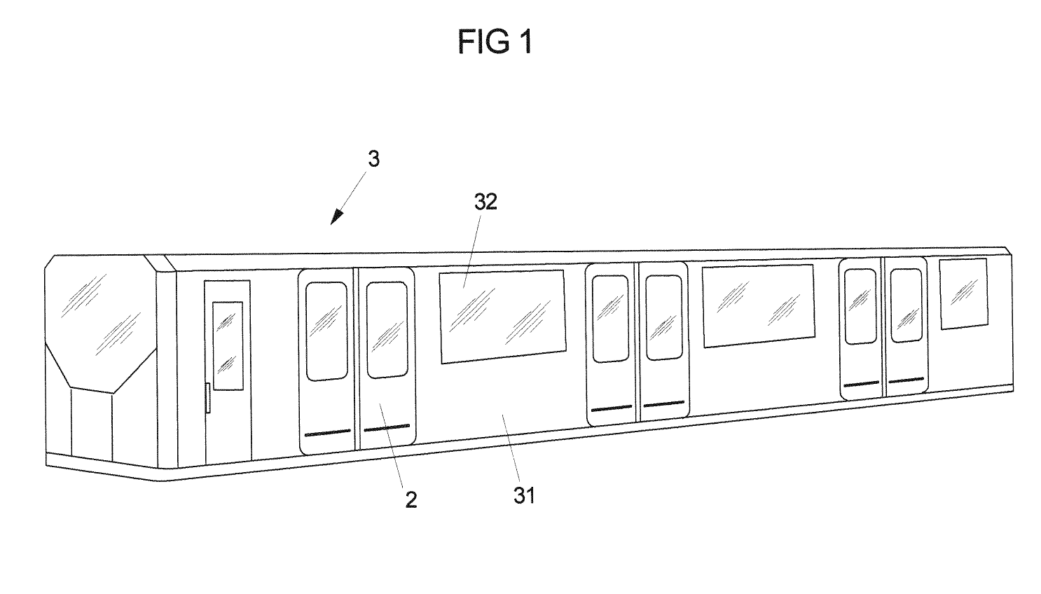

FIG. 1 shows a mass transportation vehicle,

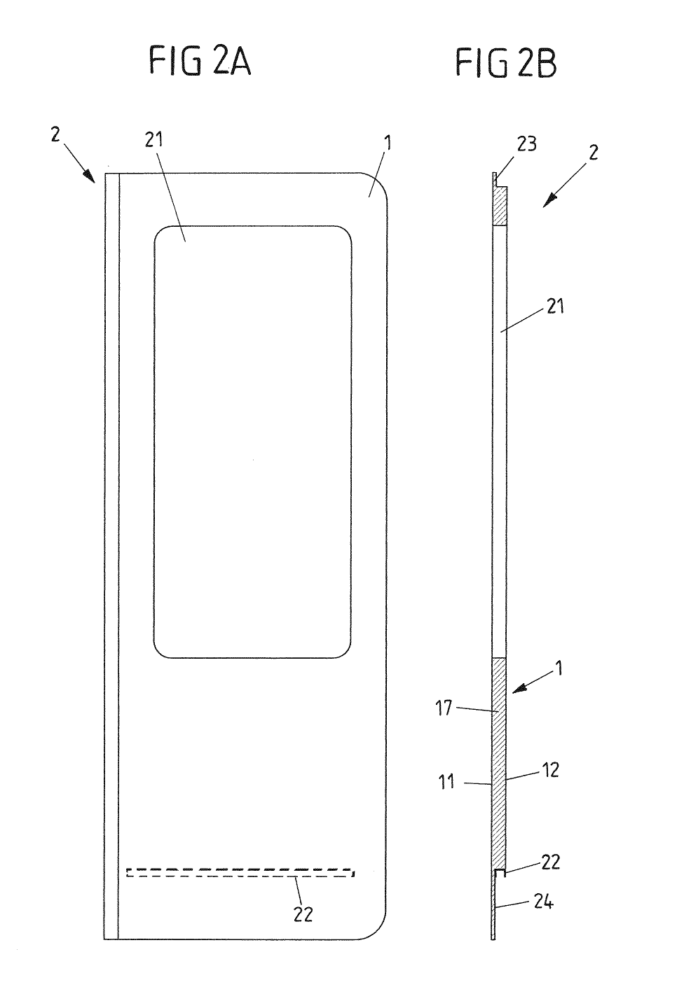

FIG. 2A shows a front view of a door for a mass transportation vehicle,

FIG. 2B shows a detail of a cross-sectional view of the door of FIG. 2A,

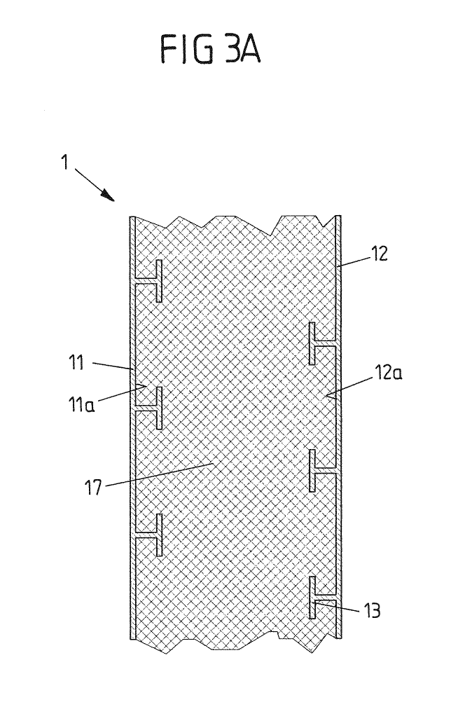

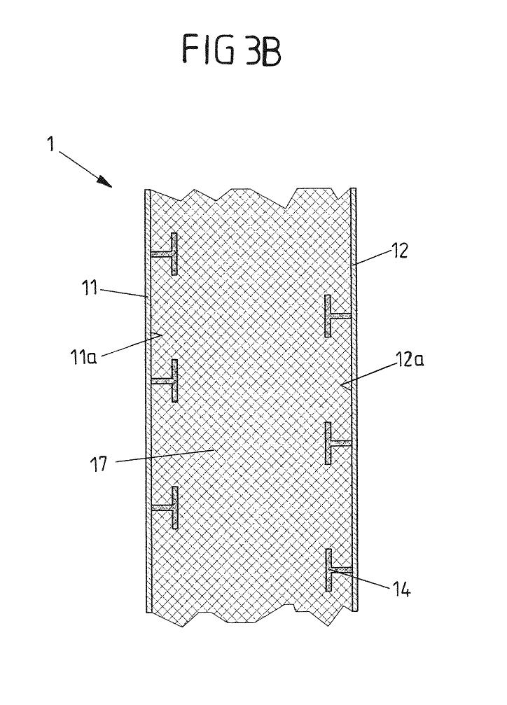

FIG. 3A shows a cross-sectional view of a first exemplary embodiment of the door leaf,

FIG. 3B shows a cross-sectional view of a modification of the first exemplary embodiment of the door leaf according to FIG. 3A,

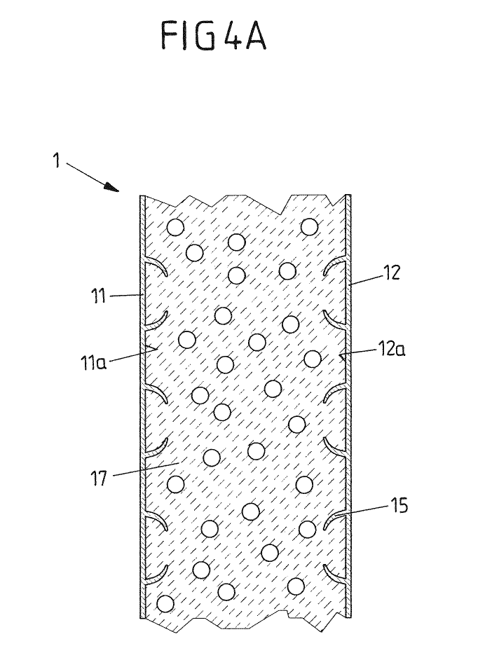

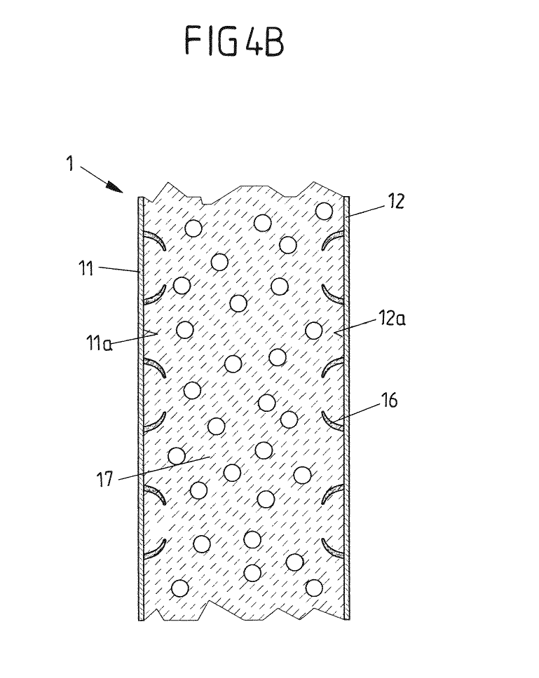

FIG. 4A shows a cross-sectional view of a second exemplary embodiment of the door leaf,

FIG. 4B shows a cross-sectional view of a modification of the second exemplary embodiment of the door leaf according to FIG. 4A,

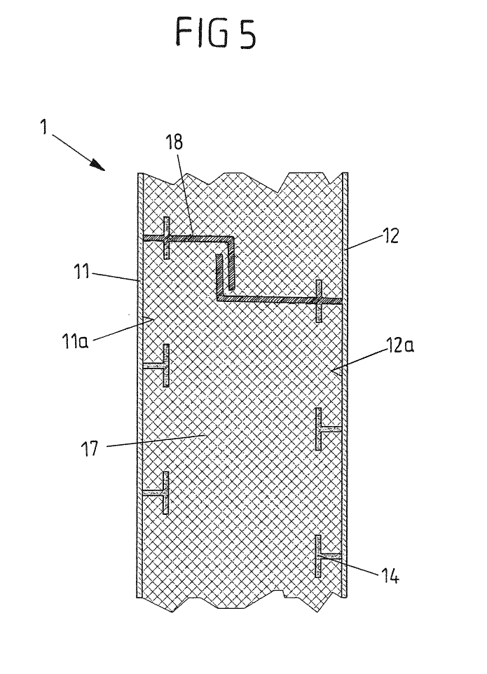

FIG. 5 shows a cross-sectional view of a third exemplary embodiment of the door leaf.

FIG. 1 shows a mass transportation vehicle 3 comprising a vehicle body 31, vehicle windows 32 and at least one door 2. The doors 2 of the mass transportation vehicle 3 will be described in greater detail with reference to the following figures.

The mass transportation vehicle 3 of FIG. 1 is a metro train and serves as an example for all other mass transportation vehicles, such as railway trains, busses, airplanes, cable cars, street cars, wagons and others.

Mass transportation vehicles such as the mass transportation vehicle 3 shown in FIG. 1 are boarded and alighted through doors. Mostly, sliding doors are used for such vehicles, such as the doors 2 in FIG. 1, but also plug doors, swing doors and other types of door systems are known.

The doors 2 of the mass transportation vehicle 3 comprise a door leaf device 1. Therefore, the doors 2 can be light and robust and provide heat and noise isolation.

There are mass transportation vehicles that only comprise one door. However, usually, mass transportation vehicles comprise more than one door, for example two doors on either side of the vehicle, eventually one or more additional doors for a driver, in some vehicles there are also doors inside the vehicle and in some types of mass transportation vehicles each two cars of the vehicle are connected by one or more doors. Often, such doors of mass transportation vehicles are constructed as double doors. For all such doors, doors 2 comprising door leaf devices 1 can be used.

FIG. 2A shows an outside view of a door 2 for a mass transportation vehicle 3, comprising a door leaf device 1, a window 21 and a rail 22 (located on the inside face of the door leaf device 1 and therefore indicated with dashed lines). FIG. 2A shows a simplified door leaf device 1 where various parts that such door leaf devices 1 may comprise are not shown. In particular, such a door leaf device 1 may comprise an upper door guide, such as a roller guide or it may comprise screws in the upper part of the door leaf device 1, connecting the door leaf device 1 with support elements and/or a door guide.

A cross-sectional view of the same door 2 is shown in FIG. 2B, where the door leaf device can be seen in more detail, having first and second panels 11, 12 and a core layer 17 in between the panels 11, 12. Also thinner upper and lower end regions 23, 24 of the door and the guide rail 22 can be seen. These upper and lower end regions 23, 24 demonstrate that the first and second panels 11, 12 do not necessarily have to be equally spaced to one another over their whole extent. The first and second panels 11, 12 are substantially parallel in FIG. 2B, but the first and second panels 11, 12 do not necessarily have to be parallel to each other; they also may be parallel in some portions and e.g. inclined towards one another in other portions.

At edges of the door leaf device 1, the first and second panels 11, 12 may e.g. be folded for a closure of the core layer. Also, coverings, in particular metallic coverings, may be arranged on edges and/or on frontal faces of the door leaf device 1. Such coverings may be formed as a cap, or in U- or L-shape or in a flat form. On edges and/or on frontal faces of the door leaf device 1 the core layer 17 may be geometrically formed for receiving sealing means. Likewise, the core layer 17 may be geometrically formed to serve as a support area and/or sealing surface for sealing means, mounted on the side of the vehicle body 3. Alternatively, also the cover layer (the first and/or second panels 11, 12 and/or said coverings) may be geometrically formed either to receive sealing means and/or to serve as a support area and/or sealing surface for sealing means, mounted on the side of the vehicle body 3.

The inner space, which is narrower in the upper and lower end regions 23, 24 of the door 2, is filled by the core layer 17. Fastening means 13, 14, 15, 16, 18 are not shown in the FIGS. 2A and 2B but part of the door 2.

Such a door 2 may swing or slide open, guided by the rail 22. It may be deployed in the mass transportation vehicle 3 but it can also be deployed in any other mass transportation vehicle, such as a train, a subway, a bus, an airplane, a cable car, a street car, and others.

In FIGS. 2A and 2B a planar door 2 is shown but a door 2 does not necessarily have to be planar. The door 2 may also be curved or bent or have kinks or a combination of such shapes. It may also be formed curved, bent and/or with kinks in some regions and be planar in other regions. Moreover, the door 2 may also have a three-dimensional shape.

FIG. 3A shows a cross-sectional view of a first exemplary embodiment of a door leaf device 1. First and second panels 11, 12 are shown, which face one another with inner side surfaces 11a, 12a. Both panels 11, 12 are arranged substantially parallel to one another and with a gap in between. As stated above, the first and second panels 11, 12 do not necessarily have to be substantially parallel. Also the gap may be thinner or broader than shown in FIG. 3A. The gap also may be thinner in some regions of the door leaf device 1 and broader in other regions of the door leaf device 1. An inner space due to the gap in between the panels 11, 12 is filled by a core layer 17.

Each of the first and second panels 11, 12 comprises a plurality of fastening means 13. In FIG. 3A, the fastening means 13 are integrally formed in one piece with the panels 11, 12. The fastening means 13 engage the core layer 17, fastening the panels 11, 12 to the core layer 17.

In FIG. 3A, the fastening means are provided with a T-shaped form but any other forms engaging the core layer are also conceivable, such as e.g. L-shapes, quarter circles, hooks, diagonal bars, wiggly lines, and others.

Such forms of the fastening means 13 lead to a form-locking engagement of the fastening means 13 in the core layer 17. Any other shape of the fastening means 13 is conceivable, which provides a form-locking engagement with the core layer 17 when it is in engagement with the core layer 17.

The core layer 17 of FIG. 3A is made of substantially homogenous polyurethane (PU) foam. Furthermore, the core layer 17 of FIG. 3A is made of rigid PU foam with a density of between 30 and 300 kg/m³, in particular with a density of between 50 and 100 kg/m³. The rigid PU foam is characterized by an indentation force deflection of between 200 and 700 kPa (compression strength at 40% compression) and a heat conductivity of between 0.02 and 0.03 W/(mK).

The core layer 17 does not necessarily have to be made of a foam material; however, when foam material is used as core layer 17, the foam can be introduced in the inner space between the first and second panels. While being introduced, the foam surrounds the fastening means, which are T-shaped in this exemplary embodiment. After being cured, the PU foam made core layer is rigid and the fastening means are securely fastened within the core layer.

Due to the shape of the fastening means 13 and the rigidity of the core layer 17, the door leaf device 1 withstands forces applied to the door leaf device 1, such as pressure, drag force, shear force and other forces occurring in the normal use of a door leaf device 1 of a mass transportation vehicle 3.

The first and second panels 11, 12 of FIG. 3A are produced by extruding. Therefore, the fastening means 13 extend on the first and second panels 11, 12 along the line of sight.

FIG. 3B shows a cross-sectional view of a modification of the first exemplary embodiment of the door leaf according to FIG. 3A.

Most components shown in FIG. 3B are the same as in FIG. 3A, also denoted with like reference numerals. Therefore reference is made to the corresponding description of FIG. 3A. The fastening means 14 in FIG. 3B, however, is not integrally formed in one piece with the first and second panels 11, 12 of the door leaf device 1. In this case, the first and second panels 11, 12 are plain sheets of metal, e.g. produced by rolling, plastics, wood, or any other material and the fastening means 14 are attached to the panels 11, 12. Attaching the fastening means 14 to the first and second panels 11, 12 may be done by welding, gluing, by means of screws, rivets, resistance welding, laser welding or any other means suitable for attaching the fastening means to the panels 11, 12.

FIG. 4A shows a cross-sectional view of a second exemplary embodiment of the door leaf 1. As in FIG. 3A, first and second panels 11, 12 provided with fastening means 15 are shown, forming an inner space in between, which is filled by a core layer 17. Here, the core layer is provided with holes or bubbles serving for a further reduction of the weight of the door leaf device 1. It is noted, that the core layer 17 may also comprise other components, e.g. parts or structures increasing the stability of the door leaf, or channels, such as cable channels, or cables or mechanical parts, wires, wire nettings and other components. Alternatively or additionally, the core layer 17 may comprise other elements as e.g. balls or cubes. In particular, such elements may be used for the optimization of various properties of the door leaf device 1, in particular acoustical properties. Such elements may be made of one specific material or of various different materials. All such components or elements may be distributed substantially homogeneous in the core layer 17, or they may be distributed inhomogeneous, e.g. there may be more or different types of such components and/or elements in some parts of the door leaf device 1 than in others.

Another difference to the door leaf device as shown in FIG. 3A is, that the fastening means 15 shown in FIG. 4A are designed in a different shape. The fastening means 15 are integrally formed in one piece with the first and second panels 11, 12, protruding on the opposing inner side surfaces 11a, 12a.

Since the fastening means 15 are formed in one piece with the panels 11, 12 such panels 11, 12, shown in FIG. 4A may e.g. be produced by extrusion or by casting. In this production process also the fastening means 15 may be formed. Alternatively, the fastening means 15 may also be furnished on the first and second panels 11, 12 mechanically and/or by reforming or working methods as e.g. rolling, embossing, milling and others.

Concerning the shape of the fastening means 15 and the construction of the core layer 17, reference is made to the description of FIG. 3A.

FIG. 4B shows a cross-sectional view of a modification of the second exemplary embodiment of the door leaf according to FIG. 4A. The only difference between FIG. 4A and FIG. 4B is, that the fastening means 16 in FIG. 4B is not formed as integral parts of the first and second panels 11, 12 but are separate parts, being attached to the panels 11, 12. In this manner, the panels may also be produced e.g. by rolling.

The fastening means shown in FIGS. 3A to 4B are particularly suited to fasten the first and second panels to the core layer, also when a drag or shear force is being applied.

FIG. 5 shows a cross-sectional view of a third exemplary embodiment of the door leaf device 1. Therein, the door leaf device 1 of FIG. 3B is shown, which is additionally provided with fastening means 18. The fastening means 18 are attached to the first and second panels 11, 12 and engage the core layer 17. Moreover, the fastening means 18, which have an L-shaped part in this example, are oppositely oriented on the first panel 11 and on the second panel 12, having sections of the L-shaped parts which overlap and thus engage behind each other. By means of such fastening means 18, the first and second panels 11, 12 are mechanically secured to one another, additionally to the fastening to one another via the core layer 17 by means of the fastening means 14, 18 engaging the core layer 17.

The length of the fastening means 18 of the first panel 11, i.e. the extension of the fastening means 18 of the first panel 11 in the direction towards the second panel 12, may be equal or different to the length of the fastening means 18 of the second panel 12, i.e. the extension of the fastening means 18 of the second panel 12 in the direction towards the first panel 11.

Such fastening means 18 may either be formed integrally in one piece with the first and second panels 11, 12 or as separate parts and attached to the first and second panels 11, 12, just as the other fastening means 13, 14, 15, 16 shown in FIGS. 3A to 4B. The L-shaped part of the fastening means 18 in FIG. 5 protrudes from a T-shaped part similar to the shape of the fastening means 14. However, the fastening means 18 also may only be L-shaped and do not comprise the part similar to the fastening means 14. On the other hand, the fastening means 18 may also comprise, be formed in one part or be attached to any other fastening means 13, 14, 15, 16.

Fastening means 18 may also be added to any of the other embodiments. Different types of fastening means as the fastening means 13, 14, 15, 16, 18, shown in the FIGS. 3A to 5 may be combined in one door leaf device 1. Especially fastening means 18 may be provided in addition to other fastening means 13, 14, 15, 16. The fastening means 18 may also be used as the only type of fastening means in one door leaf device 1. Concerning the manufacturing, the distribution on the first and second panels 11, 12 and the properties of the fastening means 18 it is referred to the description concerning the other types of fastening means 13, 14, 15, 16.

Furthermore, fastening means, as fastening means 18, having portions overlapping with respective portions of fastening means of the other one of the first and second panels 11, 12, do not necessarily have to be L-shaped. Such fastening means may also have a shape of a T, of a hook, have slanted or round portions or have any other shape suitable to overlap with and by this engage behind fastening means 13, 14, 15, 16, 18 of the other one of the first and second panels 11, 12.

### LIST OF REFERENCE NUMERALS

1 door leaf device
2 first panel
11a inner side surface
12 second panel
12a inner side surface
13, 14, 15, 16, 18 fastening means
17 core layer
2 door
21 window
22 rail
23 upper end region
24 lower end region
3 mass transportation vehicle
31 vehicle body
32 vehicle window

1. A door leaf device for mass transportation vehicles, comprising:
first and second panels, having opposing inner side surfaces, forming an inner space in between; and
a core layer, filling the inner space between the inner side surfaces of the first and second panels,
wherein the inner side surfaces of the first and second panels each comprise at least one fastening element engaging the core layer.

2. The door leaf device according to claim 1, wherein the first and second panels are fastened to the core layer by at least one fastening means element.

3. The door leaf device according to claim 1, wherein the engagement of the at least one fastening element and the core layer is a form-locking engagement.

4. The door leaf device according to claim 1, wherein the core layer comprises a foam material.

5. The door leaf device according to claim 4, wherein the foam material is polyurethane foam with a density of 30 to 300 kg/m³.

6. The door leaf device according to claim 1, wherein the first and/or second panels comprise metal.

7. The door leaf device according to claim 1, wherein the first and/or second panels are manufactured by at least one of rolling, extruding, and casting.

8. The door leaf device according to claim 1, wherein the at least one fastening element of the first and second panels is formed integrally in one piece with the first and/or second panels.

9. The door leaf device according to claim 1, wherein the at least one fastening element of the first and second panels is a separate piece and arranged on the first and/or second panels.

10. The door leaf device according to claim 1, wherein the at least one fastening means element of the first and second panels is formed as undercut or indentation in the first and/or second panels.

11. A method for producing a door leaf device for mass transportation vehicles, comprising:
producing first and second panels having inner side surfaces;
arranging the first and second panels, facing each other with the inner side surfaces, to form an inner space in between; and
filling the inner space between the first and second panels with a core material forming a core layer;
wherein the inner side surfaces of the first and second panels each comprise at least one fastening means element engaging the core layer.

12. A door for mass transportation vehicles, comprising a door leaf device according to claim 1, being produced using a method according to claim 11.

13. (canceled)

14. The door leaf device according to claim 4, wherein the foam material comprises a polyurethane (PU) foam.

15. The door leaf device according to claim 4, wherein the foam material is polyurethane with a density of 50 to 100 kg/m³.

16. The door leaf device according to claim 6, wherein the metal comprises at least one of the following: aluminum, stainless steel, or any combination thereof.

17. The door leaf device according to claim 1, wherein the first and/or second panels comprise a plastic material.

18. The door leaf device according to claim 2, wherein the engagement of the at least one fastening element and the core layer is a form-locking engagement.

19. The door leaf device according to claim 2, wherein the core layer comprises a foam material.

20. The door leaf device according to claim 3, wherein the core layer comprises a foam material.
